(19) United States
(12) Patent Application Publication
(10) Pub. No.: US 2016/0140629 A1
(43) Pub. Date: May 19, 2016

(54) METHODS FOR COMPUTING DEVICES

(71) Applicant: Solu Machines Oy, Helsinki (FI)

(72) Inventors: Joona KALLIO, Espoo (FI); Kristoffer LAWSON, Espoo (FI); Pekka NIKANDER, Helsinki (FI); Javier REYES, Helsinki (FI)

(21) Appl. No.: 14/881,572

(22) Filed: Oct. 13, 2015

(30) Foreign Application Priority Data
Nov. 18, 2014 (FI) 20140309

(51) Int. Cl. G06Q 30/02

(52) U.S. Cl. CPC G06Q 30/0283

(57) ABSTRACT

The invention relates to novel types of computing devices, their operating systems, and ecosystems supporting such computing devices. The invention is especially related to new ways of providing compensation to software providers.

### BACKGROUND OF THE INVENTION

The invention relates to novel types of computing devices, their operating systems, and ecosystems supporting such computing devices.

Application markets are a well known paradigm. For example, Apple Inc. provides a marketplace, “App Store”, for users of its iOS-based computing devices. Software providers can distribute their applications to users via the App Store, and customers can download the applications to their mobile devices from the App Store. Some software is available at the App Store without cost, while large numbers of applications require the customer to pay for the applications they wish to download to their device. A similar structure is provided by Google Inc. for users of computing devices running the Android operating system. These software application marketplaces have the benefit of allowing even small firms or individuals to produce an application, and have the application be available to large numbers of customers. The marketplaces make it possible for application creators to charge very small sums for a single license, while allowing for the possibility of large profits from exposure to very large numbers of possible customers. The generally very low license prices make it easy for a customer to buy a new application for her computing device.

However, charging for a license does still require an action and a decision from the customer, even though the charge may be small. This is a factor that often limits popularity of software applications. Further, this decision is typically irreversible—typically a customer cannot return the product, even if they did not like it after trying the software application.

Time-based solutions are also known. One service that is very well known at the time of writing of this specification is the Spotify music service, available on the Internet at http://www.spotify.com. In this service, users pay a fixed monthly fee.

Artists who have licensed content to be used within this service receive a compensation based on how many times their content have been played by the users.

### SUMMARY OF THE INVENTION

The inventors have invented methods for providing computing devices and an ecosystem for computing devices, where users pay for use of the devices—e.g. with a low monthly payment—and are then able to use any software licensed for use within the ecosystem without further cost, and without having to license different software applications separately. The application vendors can then receive their share of the monthly payments based at least in part on the popularity of their applications, on how much their applications are used. Such an arrangement removes the need for users to consider whether or not they have some desired software licensed and installed, and removes the need to buy many different pieces of software from an application software market—thus increasing the usage of various applications by the users. This arrangement also allows the providers of software to benefit from the popularity of their software applications. Also, since this arrangement allows the users to use any software available within the ecosystem, there will be less piracy than in current models, where users need to buy software applications. The inventive revenue assigning model triggers the possibility of developers to get paid regardless of the users' awareness as to whether they are using their application or not.

The invention provides benefits for the users of computing devices as well as for software developers producing software and/or content for computing devices. For example, the inventive model allows an user to test a piece of software without need to invest in a license for the software. It is known for software developers to produce trial versions of their software in order to allow customers to try out the software before committing to a license purchase. For the users, trial versions have the drawback that they commonly are somehow limited in functionality or usage time or in some other way to motivate users to buy the license. For software developers, the inventive model removes the need for software developers to produce and maintain trial versions of their software, which saves their effort.

The inventive methods present ways of determining, how much a user of a computing device uses various applications, and how much resources these applications use on the device itself and/or on a cloud service, and heuristics for estimating the utility value a user gets from using these applications. These determinations allow compensation of application vendor according to the usage of their applications, while taking into account the use of hardware resources (CPU or central processing unit time, memory allocation, storage, I/O) by the applications in such a way, that high resource usage by an application decreases the compensation of the vendor of that application.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

Various embodiments of the invention will be described in detail below, by way of example only, with reference to the accompanying drawings, of which

FIG. 1 illustrates a computing device according to an aspect of the invention,

FIG. 2 illustrates a method according to a further aspect of the invention, and

FIG. 3 illustrates another method according to a still further aspect of the invention.

### DETAILED DESCRIPTION

### 1. Certain Methods for Monitoring Use of a Computing Device

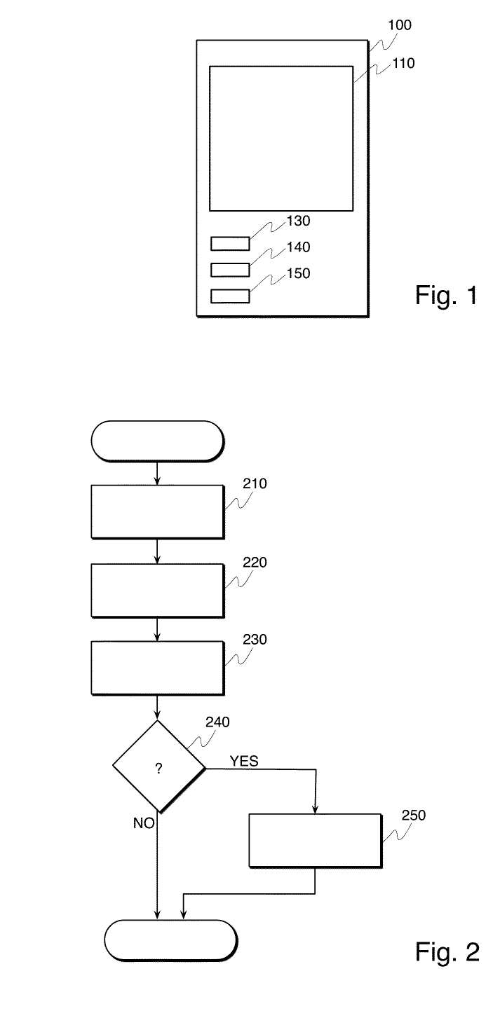

The following description concerns certain methods in computing device. FIG. 1 illustrates a portable computing device 100 having a touch screen display 110. The portable computing device may comprise a processor (CPU) 130, random access memory 140, mass memory 150 such as flash memory or other non-volatile memory, communication circuitry, a touch screen display 110, and a rechargeable battery or other power source. The communication circuitry can comprise for example circuitry for wireless communication, circuitry for wired communication, or for example circuitry for optical communication. The wireless communication circuitry can advantageously be able to communicate over a WLAN, WiMax, cellular, Bluetooth and/or any other type of wireless communication standard. The wired communication circuitry can advantageously be able to communicate over an Ethernet link, an USB link, or any other preferably high-speed link. The circuitry for optical communication can advantageously be able to communicate over an optical fiber or through any other optical device. The portable computing device can advantageously also further comprise one or more cameras.

In an advantageous embodiment of the invention, the use of the computing device is monitored to determine a proxy value for the benefit provided by a piece of software to the user. These proxy values for various pieces of software in the computing device are aggregated for a period of time, and the resulting distribution of value is used in compensating the providers of the pieces of software. In the following description, we use the term accrued value to describe the result, i.e. the relative portion of the usage of the computing device, and/or the benefit gained from such usage, assigned to a piece of software as a result of various methods of monitoring, value aggregation, calculation and accounting of these monitored values. The accrued value can be represented by a single value, or for example as a set of values which are used in the calculation of compensation for software providers.

At a first level, the monitoring of usage can be performed by measuring in various ways how much a user uses different pieces of software on his computing device. This measuring can be performed in many different ways, and different partial measurements can be weighted in many different ways and combinations.

Further, a computing system comprises many different software components, only some of which are present at the user interface and directly used by the user of the computing device. For example, a large software application can comprise many different but separate components, where some of the components provide for the user interface of the application and others provide services for these user interface components or otherwise handle tasks in the background. Also, there are many types of software components that do their tasks within the operating system, never interacting with the user. In order to provide a compensation also to pieces of software that do not directly interact with the user, methods for attributing value to such pieces of software are needed. Such methods are also described in the following.

In an advantageous embodiment of the invention, these methods for monitoring the usage of different applications are used for monitoring the usage of different pieces of content, allowing the use of the same infrastructure that provides for compensation of software application providers also for providing compensation to producers of various kinds of media. The inventors have had the insight, that this infrastructure can be used to monitor the use of any kind of objects within the computing device and the ecosystem, irrespective of whether the objects are software applications, underlying system software, or different types of content provided for consumption by the users of the computing devices.

The inventors have identified a number of advantageous factors, which can be monitored by the computing device, and can be used as a proxy value and/or in calculation of a proxy value for the benefit provided by an application, another piece of software or any other type of object to the user.

A first advantageous monitoring value is the area used by the application in the user interface provided by the computing device. This can be integrated over a time period in order to provide not just an instantaneous value, but an aggregate value over that time period.

A second advantageous monitoring value that is related to said first advantageous monitoring value, is the display area of an application that is visible to the user, i.e. not covered by user interface elements of other applications, in the user interface provided by the computing device. This second advantageous monitoring value can also be integrated over a time period in order to provide not just an instantaneous value, but an aggregate value over that time period.

A third advantageous monitoring value is the number of input events caused by the user and received by an application during a time period.

A further advantageous monitoring value is the amount of changes of the content of a window of an application. A high level of changes in the content can be used as a rough approximation of the level of activity of using the application. Further, this monitoring value is well suited to monitoring the usage of different types of content by the user and the value of the content to the user. If the content is static and the user merely scrolls the content in a window, the amount of changes in the window is relatively low. On the other hand, if the content is dynamic and changing continuously, such as in the case of a film, the amount of changes in the window is large. These two extreme examples roughly match the variability in the producing costs of the content: a blockbuster movie is typically much more expensive to produce than a book. Consequently, this type of monitoring (and consequent variations in compensation) may match the business requirements of content producers, and therefore be a benefit to the ecosystem as a whole.

Further, an advantageous monitoring value is the amount of changes of the content of a canvas belonging to a window of an application. The canvas of a window is a well known and widely used windowing system concept, and may be described in a simplified way as being a virtual area that may be larger than the window, in which case the windows shows only a part of the canvas. Scrolling a document within a window can be implemented by generating a canvas displaying the document, and then simply changing the location within the canvas which the window actually displays. Consequently, mere scrolling of a document in such a case may not require any change in the canvas itself, only a change of the location of the canvas related to the window. In such a case, mere scrolling of a document would not be monitored as a change in the canvas itself

In a further advantageous embodiment of the invention, the kind of activity that the user does can also be used as a factor in monitoring input events. For example, active typing via a keyboard can be associated with a higher value than merely scrolling with arrow keys on the keyboard, or controlling a piece of software through the touch screen of the computing device. Further, if the computing device is able to detect gestures above the computing device by using e.g. cameras or other gesture detecting technology, these input events can also be classified in their own class, and be associated with a specific weight value. These examples highlight the basic observation that the type of activity performed by the user can be used as a factor.

These monitoring values can advantageously be used in combination. For example, in one advantageous embodiment of the invention, the causality between input events and changes in the content of a window or a canvas are taken into account. For example, input events that causally correlate with changes in window and/or canvas contents may be given higher weight than input events that do not correlate with window and/or canvas changes.

Further, monitoring values can be used as parameters of a predetermined function to obtain a further monitoring value. For example, in order to place greater monitoring value weight on the active use of an application window, the system can use as a monitoring value the product of frequency of input events related to the application window, and the size of the application window. This multiplication can also be a weighted multiplication. Further, the mathematical function combining two or more monitoring values can be any mathematical function or formula.

In a further advantageous embodiment of the invention, time correlation of input events and changes in window and/or canvas contents are taken into account. For example, input events that are followed by changes in a window or a canvas within a specified time may be given higher weight than input events that do not have any following window and/or canvas changes.

These aforementioned heuristics of using causal or time-based correlations are only examples of possible heuristics that can be used for determining monitoring values, and many other types of heuristics and combinations can be used.

In a still further advantageous embodiment of the invention, different input events are given different weights, i.e. some input events are considered to affect a monitoring value more than some other input events. This recognizes that different input events require more effort and concentration from the user than others, and thus represent more value than others. In various embodiments of the invention, input events can be classified and valued in many different ways.

Monitoring of input events can in various embodiments of the invention be implemented in many different locations in an operating system. An operating system can have a plurality of different input streams, such as input stream from a touch screen, input stream from a keyboard, input stream from a touchpad, or for example an input stream from a mouse. One known arrangement to handle such input streams is to have an input manager software element to receive these different input streams, and the input manager then forwards input events to other parts of the operating system. The input manager can typically process input events before forwarding, for example to change formats of input event messages, combine input events, remove certain input events, or for example duplicate input events for forwarding to more than one processing paths. The input manager can also forward different input events to different pieces of software. For example, the input manager can forward certain input events to a window manager program, others to various software applications running on the computer, and still others to various other parts of the operating system.

Since there can be different paths and processing steps for managing input events in an operating system, various embodiments of the invention can implement monitoring of input events in different parts of input event processing paths. For example, monitoring of input events pertaining to a piece of software can be performed at the location in an input event processing path, where the input events are transferred to said piece of software. However, input events can be monitored in other locations as well.

There are many different ways of collecting information for determining the monitoring values. For example, the windowing system of the user interface of the computing device can be enhanced with functionality to measure and report the area covered by a window on a screen. For another example, the graphics subsystem of the user interface can be enhanced to count the number of changes on a canvas. The input event processing routines of a windowing system can be enhanced to count the input events. These are only rough examples of different ways to include actual functionality to monitor different aspects of user interface operation, and different ways of realizing such monitoring can be devised by a man skilled in the art.

In a typical computing system, user-visible software applications use various software libraries, other pieces of software such as various background services, and other resources in the computing system. In order to provide compensation also to providers of such lower level software, some of the accrued value from the use of a software application by a user is in an advantageous embodiment of the invention assigned to such lower level software. This can be realized in many different ways, for example by monitoring which pieces of lower level software such as library functions or executables are called by the software application directly used by the user.

In an advantageous embodiment of the invention, the accruing of value for a piece of software is at least in part determined also by the uniqueness of the service or functionality that the piece of software provides. If the piece of software is merely one of a large number of software applications providing the same or a similar functionality, the use of that piece of software is given less weight than the use of a piece of software providing a highly unique functionality. One example of a possible way to determine whether a given software application provides unique or common functionality is to examine mime types supported by the application. The concept of a mime type is well known to a man skilled in the art, and is generally used to indicate which type of information a file contains. In many operating systems, mime types are used to indicate which file types can be opened by which software applications. Typically, software applications indicate to the operating system, or register with the operating system, which mime types the software application can open.

In an advantageous embodiment of the invention, accrued value for a software application is at least in part calculated by determining which mime types the software application supports, and how many software applications are known to support those mime types. The more unique the supported mime types are, the more accrual value is assigned to said software application.

In an advantageous embodiment of the invention, value calculation is performed at least in part based on a mime type associated with an object such as a file that a user is using with a software application. If there are many software applications supporting objects having that mime type, said software application receives less accrual value for that use by the user than in the case, where there are few other software applications supporting that mime type. If there are many applications supporting the use of files of this particular mime type, the benefit gained by the user from the use of this particular software application is by this calculation method weighted to be smaller than the benefit gained by the user from the use of a highly specialized application.

In a further advantageous embodiment of the invention, the calculations of accrued value at least partly in the basis of a mime type takes also account the popularity of software applications supporting that mime type, by giving more weight to applications that are used most with that mime type. Such weighting based on popularity increases effect of user preferences on rewards provided to the application creators, i.e. allows the users to “vote with their feet”.

A class of well known problems with application software can arise, if a software provider does not provide updates for a software application. Typically, if the application itself performs sufficiently well, no problems might arise for a period of time after publication of that version of the software application. However, as time goes on and an operating system and an associated software ecosystem continue being developed, services and application program interfaces (API) change. If the software provider does not update his software application, the application might not fully work anymore, or might disturb the operation of the operating system or other pieces of software. Various embodiments of the invention that are described in the following paragraphs, provide at least some help with these problems.

In a further advantageous embodiment of the invention, the calculations of accrued value of a piece of software take into account which application program interfaces (API) and services, and which versions of APIs and services are used by the piece of software. If a piece of software uses an API or a version of an API or a service that is denoted as old and/or deprecated, the accrued value of that piece of software can be partially reduced or even completely reduced to zero. The service can be an operating system service that is provided by the operating system within a computing device, but can also be a network service that is provided externally to the computing device. The API can be an interface internal to the computing device, or a network API residing externally to the computing device. Such an embodiment has the advantage, that the use of old and/or deprecated interfaces and/or services by application programmers can be strongly discouraged, in order to encourage application programmers to update their applications to use current versions of interfaces and/or services, since reduction in the accrued value of an application reduces their income stream from the application. Such an embodiment also provides the advantage, that by giving a strong incentive for application developers to keep their software updated, the need for maintaining of old and deprecated services and interfaces is reduced, which saves effort and costs.

In different embodiments of the invention the reduction of accrual value due to use of an old and/or deprecated interface and/or service can be performed in many different ways. For example, the degree of reduction of an accrual value can be performed in a gradual way so that use of an old API or service that is not many releases behind the current one, causes only a small reduction, but the use of a still older version of an API or service causes a larger reduction. Such an embodiment has the advantage, that it gives software providers an initially soft, but later in time growing incentive to update a piece of software.

In a further advantageous embodiment of the invention, the calculations of accrued value take into account a predefined set of rules which software applications need to follow, and if a software application functions outside said rules, its accrued value is reduced or removed. The set of rules can for example define limitations of use of selected operating system resources, define penalties associated with use of selected operating system resources, define penalties for actions that reduce security, anonymity and/or privacy of the user, or for example define certain APIs or API versions that should not be used any more. The invention is not limited to these examples of rules, and can be implemented with many other rules defining different aspects of other types of undesirable behavior, resource use, or other undesirable details.

Such a set of rules can for example specify penalties associated with excessive uses of system memory, storage space or other resources. Such a set of rules would provide an incentive for application software creators to optimise their products and to avoid unnecessary use of resources of the computing device, resulting in a better overall performance of the computing device.

In a further advantageous embodiment of the invention, if a software application behaves in an unsafe ways e.g. by leaking private information outside an allowed area of use, the application can be penalized by decreasing or removing its accrued value. This provides a strong incentive for the creators of the software application to update their application. Further, if security holes are found, the accrued value of any piece of software containing that security hole can be decreased or removed.

In a further advantageous embodiment of the invention, a piece of monitoring functionality is implemented in a context switching mechanism of the operating system of the computing device. A context switch is a concept well known to a man skilled in the art of multitasking operating systems. A short and rough explanation of the concept is that a context switch is the process of storing and restoring the state (context) of a process or thread so that execution can be resumed from the same point at a later time. This allows sharing of a single CPU between a number of processes. In this embodiment of the invention, the context switching mechanism is enhanced with functionality for storing and/or generating information about the process switched from and/or switched to for later calculation of how much various pieces of software in the computing device use other, lower level software.

In a further advantageous embodiment of the invention, a piece of monitoring functionality is implemented in the process scheduler in the operating system. The process scheduler is generally known as the software component in the kernel of the operating system that is responsible for governing the execution of all processes by the CPU. In this embodiment of the invention, the process scheduler is enhanced with functionality for storing and/or generating information about which processes are executed for later calculation of how much various pieces of software in the computing device use other, lower level software.

In a further advantageous embodiments of the invention, cgroups are used in monitoring of usage of processes and resources by a software application. Cgroups (control groups) is a Linux kernel feature, which is generally used to limit, account, and isolate resource usage of process groups. The cgroups functionality provides an advantageous way to collect information about a hierarchy of processes used by an application, and the hardware resource usage of the hierarchy of processes.

There are many different known methods for process accounting, memory accounting, and other types of resource accounting that can be used for gathering information for later calculation of resource usage and/or how much various pieces of software in the computing device use other, lower level software. The invention is not limited to using any single method for collecting such information. Many different sources of monitoring information can be used in different combinations in different embodiments of the invention.

In an advantageous embodiment of the invention, monitoring and collecting information results in a set of information describing how much each piece of software uses which lower level pieces of software over a period of time. This set of information can then be used to calculate compensation for providers of lower level software, that are not directly used by the user.

In a further advantageous embodiment of the invention, a percentage of the accrued value for a piece of software is in compensation calculations allocated to lower-level pieces of software used by said piece of software.

This percentage is a parameter to be adjusted in any implementations of the invention, and the invention is not limited to any specific value of this set percentage. Further, or example, the set percentage can be different at different levels of the software stack. The percentage can also be determined on an individual basis per piece of software, for example to allow providers of software to compete on price, by setting a low percentage in order to increase the use of their pieces of software by other software providers. The percentage can also be subject to agreement between individual providers of software, or be set according to market demand.

One further factor in determining the value brought by an application is the resource usage of the application. Such resources can be for example (but not limited to) any hardware resources of the computing device such as CPU (central processing unit) time, cache space, memory and mass storage; any communication resources such as amount of input/output traffic; and any resources used in a cloud service providing services to the computing device.

In order to promote resource efficiency and reduce code bloat, it is advantageous to assign a cost to using system resources. This can advantageously be performed by decreasing accrued value of a piece of software on the basis of resource usage by the piece of software. This approach provides a motivation for software developers to try to conserve resources and avoid unnecessary code bloat in their own code.

In a further advantageous embodiment, the resource usage of lower-level software used by a piece of software also decreases the accrued value of that piece of software. This approach provides a motivation for software developers to optimize resource use caused by their software.

The inventive methods of determining compensation for software and content providers do not preclude any entity from providing more expensive content and/or software for which users are required to pay. However, usage data from the inventive methods can be used as a basis of setting license fees. For example, a provider of an expensive Computer Aided Design software package could sell licenses to their software on a pay-as-you-go-basis, based on usage data from the inventive system. For example, a content provider, such as a provider of movies or music, can provide access to their content and use usage data from the inventive system as a basis for billing for the content.

### 2. Certain Further Aspects of the Invention

According to a first aspect of the invention, a method for determining compensation to a plurality of software providers for at least one piece of software provided by said software providers and used on a plurality of computing devices is provided. This aspect is illustrated in FIG. 2. According to this first aspect of the invention, the method comprises at least the steps of
collecting 210 accrued value information from said plurality of computing devices, said accrued value information comprising at least one accrued value per each of said at least one piece of software provided by the software providers and used on at least one computing device of said plurality of computing devices,
collecting 220 said accrued value information over a period of time, and
determining 230 a compensation value for each of said plurality of software providers at least in part on the basis of said collected accrued values.

In further advantageous embodiments of the invention, the method may take into account in calculation of compensation values also other factors, such as various system wide policies and rules. The method may also include further calculation steps.

In a further advantageous embodiment according to this first aspect of the invention, the method further comprises the steps of
determining 240 if a piece of software used on at least one computing device uses a deprecated application program interface or a deprecated operating system service or a deprecated network service,
and if it does, decreasing 250 at least one of the following: an accrual value related to said piece of software, or a compensation value related to the provider of said piece of software.

In a further advantageous embodiment according to this first aspect of the invention, the method further comprises the steps of
determining if the behavior of a piece of software used on at least one computing device breaks a predefined rule,
and if it does, decreasing at least one of the following: an accrual value related to said piece of software, or a compensation value related to the provider of said piece of software.

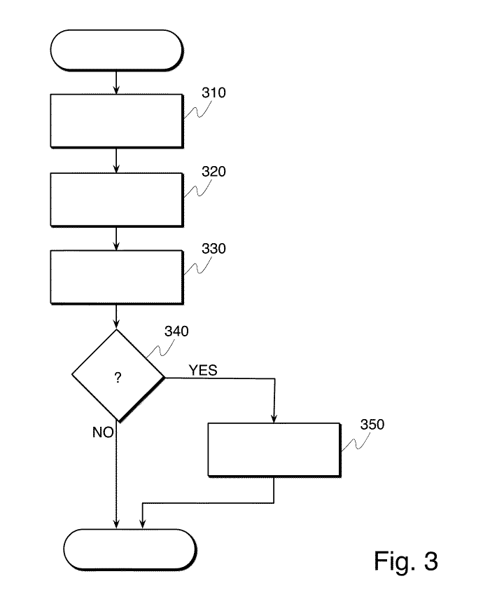

According to a second aspect of the invention, a method in a computing device is provided. An embodiment of the invention according to this aspect of the invention is illustrated in FIG. 3. According to this aspect of the invention, this method provides information related to a plurality of pieces of software executed on the computing device, and comprises at least the steps of
determining 310 an intermediate value for a piece of software on the basis of how much a user of the computing device uses said piece of software, and
calculating 320 an accrual value for said piece of software at least in part on the basis of said intermediate value.

Said piece of software can be a software application used directly or indirectly by an user, a library called by a piece of software used directly or indirectly by an user, another piece of software further down the execution chain of pieces of software calling lower-level pieces of software, or for example a background process.

In a further advantageous embodiment according to this second aspect of the invention, determination of how much a user of the computing device uses a piece of software is performed at least in part by monitoring input events for said piece of software.

In a further advantageous embodiment according to this second aspect of the invention, determination of how much a user of the computing device uses a piece of software is performed at least in part by determining how much an user interface element created by said piece of software is visible to a user of said computing device.

The user interface element can be for example an application window, or any other user-visible element of a computer user interface.

In a further advantageous embodiment according to this second aspect of the invention, calculation of an accrual value for said piece of software is performed at least in part on the basis of determining how much said piece of software uses a resource of the computing device.

The resource can be for example random access memory, mass storage, processor load, or for example network connection capacity. However, the invention is not limited to monitoring of the use of any of these, as there can be many other different types of resources in a computing device or its network environment, whose use can be taken into account in determining of resource usage by a piece of software.

In a further advantageous embodiment according to this second aspect of the invention, the method further comprises the steps of
monitoring 330 the behavior of said piece of software,
determining 340 whether the behavior of said piece of software breaks a predefined rule,
and if the behavior of said piece of software breaks said predefined rule, decreasing 350 an accrual value associated with said piece of software.

In a further advantageous embodiment according to this second aspect of the invention, the method further comprises the steps of
determining if said piece of software accesses a deprecated application program interface or a deprecated operating system service or a deprecated network service,
and if it does, decreasing an accrual value associated with said piece of software. According to a third aspect of the invention, a computing device is provided. FIG. 1 illustrates a computing device 100 according to an advantageous embodiment of the invention. According to this third aspect of the invention, the computing device 100 comprises a memory device 140, 150 for storing executable pieces of software, a processor 130 for executing pieces of software stored in the memory device, and a display 110 for interacting with a user of the computing device, wherein
said processor 130 is arranged to determine an intermediate value for a piece of software on the basis of how much a user of the computing device uses said piece of software,
and calculate an accrual value for said piece of software at least in part on the basis of said intermediate value.

According to a further advantageous embodiment according to this third aspect of the invention, said processor is arranged to determine how much a user of the computing device uses a piece of software at least in part by monitoring input events for said piece of software.

According to a further advantageous embodiment according to this third aspect of the invention, said processor is arranged to determine how much a user of the computing device uses a piece of software at least in part by determining how much an user interface element created by said piece of software is visible to a user of said computing device.

According to a further advantageous embodiment according to this third aspect of the invention, said processor is arranged to calculate an accrual value for said piece of software at least in part on the basis of how much said piece of software uses a resource of the computing device.

According to a further advantageous embodiment according to this third aspect of the invention, said processor is arranged to
monitor the behavior of said piece of software,
determine whether the behavior of said piece of software breaks a predefined rule,
and if the behavior of said piece of software breaks said predefined rule, decrease an accrual value associated with said piece of software.

According to a further advantageous embodiment according to this third aspect of the invention, said processor is arranged to
determine if said piece of software accesses a deprecated application program interface or a deprecated operating system service or a deprecated network service,
and if it does, decrease an accrual value associated with said piece of software.

According to a fourth aspect of the invention, a computer software program product is provided. In an advantageous embodiment according to this aspect of the invention, when the software program product is executed by a processor of a computing device, the software program product causes the processor to
determine an intermediate value for a piece of software on the computing device on the basis of how much a user of the computing device uses said piece of software,
and calculate an accrual value for said piece of software at least in part on the basis of said intermediate value.

The software program product can be provided in many different ways, for example saved on a memory means such as a CD-ROM, a flash memory device, a hard disk, as a software package downloadable from a network service, or for example in a memory device in a computing device.

In a further advantageous embodiment according to this fourth aspect of the invention, the software program product when executed by a processor further causes the processor to determine how much a user of the computing device uses a piece of software at least in part by monitoring input events for said piece of software.

In a further advantageous embodiment according to this fourth aspect of the invention, the software program product when executed by a processor further causes the processor to determine how much a user of the computing device uses a piece of software at least in part by determining how much an user interface element created by said piece of software is visible to a user of said computing device.

In a further advantageous embodiment according to this fourth aspect of the invention, the software program product when executed by a processor further causes the processor to calculate an accrual value for said piece of software at least in part on the basis of how much said piece of software uses a resource of the computing device.

In a further advantageous embodiment according to this fourth aspect of the invention, the software program product when executed by a processor further causes the processor to
monitor the behavior of said piece of software,
determine whether the behavior of said piece of software breaks a predefined rule,
and if the behavior of said piece of software breaks said predefined rule, decrease an accrual value associated with said piece of software.

In a further advantageous embodiment according to this fourth aspect of the invention, the software program product when executed by a processor further causes the processor to
determine if said piece of software accesses a deprecated application program interface or a deprecated operating system service or a deprecated network service,
and if it does, to decrease an accrual value associated with said piece of software.

In view of the foregoing description it will be evident to a person skilled in the art that various modifications may be made within the scope of the invention. While a preferred embodiment of the invention has been described in detail, it should be apparent that many modifications and variations thereto are possible, all of which fall within the true spirit and scope of the invention.

1. A method for determining compensation to a plurality of software providers for at least one piece of software provided by said software providers and used on a plurality of computing devices, comprising at least the steps of
collecting accrued value information from said plurality of computing devices,
said accrued value information comprising at least one accrued value per each of said at least one piece of software provided by the software providers and used on at least one computing device of said plurality of computing devices,
collecting said accrued value information over a period of time, and
determining a compensation value for each of said plurality of software providers at least in part on the basis of said collected accrued values.

2. A method according to claim 1, further comprising the steps of
determining if a piece of software used on at least one computing device uses a deprecated application program interface or a deprecated operating system service or a deprecated network service,
and if it does, decreasing at least one of the following: an accrual value related to said piece of software, or a compensation value related to the provider of said piece of software.

3. A method according to claim 1, further comprising the steps of
determining if the behavior of a piece of software used on at least one computing device breaks a predefined rule,
and if it does, decreasing at least one of the following: an accrual value related to said piece of software, or a compensation value related to the provider of said piece of software.

4. A method in a computing device for providing information related to a plurality of pieces of software executed on the computing device, comprising at least the steps of
determining an intermediate value for a piece of software on the basis of how much a user of the computing device uses said piece of software,
and calculating an accrual value for said piece of software at least in part on the basis of said intermediate value.

5. A method according to claim 4, wherein
determination of how much a user of the computing device uses a piece of software is performed at least in part by monitoring input events for said piece of software.

6. A method according to claim 4, wherein
determination of how much a user of the computing device uses a piece of software is performed at least in part by determining how much an user interface element created by said piece of software is visible to a user of said computing device.

7. A method according to claim 4, wherein calculation of an accrual value for said piece of software is performed at least in part on the basis of determining how much said piece of software uses a resource of the computing device.

8. A method according to claim 4, further comprising the steps of
monitoring the behavior of said piece of software,
determining whether the behavior of said piece of software breaks a predefined rule,
and if the behavior of said piece of software breaks said predefined rule, decreasing an accrual value associated with said piece of software.

9. A method according to claim 4 further comprising the steps of
determining if said piece of software accesses a deprecated application program interface or a deprecated operating system service or a deprecated network service,
and if it does, decreasing an accrual value associated with said piece of software.

10. A computing device comprising a memory device for storing executable pieces of software, a processor for executing pieces of software stored in the memory device, and a display for interacting with a user of the computing device, wherein
said processor is arranged to determine an intermediate value for a piece of software on the basis of how much a user of the computing device uses said piece of software,
and calculate an accrual value for said piece of software at least in part on the basis of said intermediate value.

11. A computing device according to claim 10, wherein said processor is arranged to determine how much a user of the computing device uses a piece of software at least in part by monitoring input events for said piece of software.

12. A computing device according to claim 10, wherein said processor is arranged to determine how much a user of the computing device uses a piece of software at least in part by determining how much an user interface element created by said piece of software is visible to a user of said computing device.

13. A computing device according to claim 10, wherein said processor is arranged to calculate an accrual value for said piece of software at least in part on the basis of how much said piece of software uses a resource of the computing device.

14. A computing device according to claim 10, wherein said processor is arranged to
monitor the behavior of said piece of software,
determine whether the behavior of said piece of software breaks a predefined rule,
and if the behavior of said piece of software breaks said predefined rule, decrease an accrual value associated with said piece of software.

15. A computing device according to claim 10, wherein said processor is arranged to
determine if said piece of software accesses a deprecated application program interface or a deprecated operating system service or a deprecated network service,
and if it does, decrease an accrual value associated with said piece of software.

16. A computer software program product which when executed by a processor of a computing device, causes the processor to
determine an intermediate value for a piece of software on the computing device on the basis of how much a user of the computing device uses said piece of software,
and calculate an accrual value for said piece of software at least in part on the basis of said intermediate value.

17. A computer software program product according to claim 16, further causing the processor to determine how much a user of the computing device uses a piece of software at least in part by monitoring input events for said piece of software.

18. A computer software program product according to claim 16, further causing the processor to determine how much a user of the computing device uses a piece of software
at least in part by determining how much an user interface element created by said piece of software is visible to a user of said computing device.

19. A computer software program product according to claim 16, further causing the processor to calculate an accrual value for said piece of software at least in part on the basis of how much said piece of software uses a resource of the computing device.

20. A computer software program product according to claim 16, further causing the processor to
monitor the behavior of said piece of software,
determine whether the behavior of said piece of software breaks a predefined rule,
and if the behavior of said piece of software breaks said predefined rule, decrease an accrual value associated with said piece of software.

21. A computer software program product according to claim 16, further causing the processor to
determine if said piece of software accesses a deprecated application program interface or a deprecated operating system service or a deprecated network service,
and if it does, to decrease an accrual value associated with said piece of software.
